(19) United States
(12) Patent Application Publication
(10) Pub. No.: US 2026/0071902 A1
(43) Pub. Date: Mar. 12, 2026

(54) SENSOR

(71) Applicant: KABUSHIKI KAISHA TOSHIBA, Tokyo (JP)

(72) Inventors: Akira FUJIMOTO, Kawasaki Kanagawa (JP); Yosuke AKIMOTO, Yokohama Kanagawa (JP); Yoshihiko KURUI, Chigasaki Kanagawa (JP); Hiroshi HAMASAKI, Hiratsuka Kanagawa (JP)

(73) Assignee: KABUSHIKI KAISHA TOSHIBA, Tokyo (JP)

(21) Appl. No.: 19/284,864

(22) Filed: Jul. 30, 2025

(30) Foreign Application Priority Data
Sep. 10, 2024 (JP) 2024-156569

(51) Int. Cl. G01F 1/56

(52) U.S. Cl. CPC G01F 1/56

(57) ABSTRACT

According to one embodiment, a sensor includes a base, first and second structures. The first structure includes a first fixed portion and a first element portion. The first element portion includes a first resistance layer and a first conductive layer provided between the base and the first resistance layer. The second structure includes a second fixed portion and a second element portion. The second element portion includes a second resistance layer and a second conductive layer provided between the base and the second resistance layer. A first resistance layer width in the second direction of the first resistance layer is smaller than a first conductive layer width in the second direction of the first conductive layer. A second resistance layer width in the second direction of the second resistance layer is smaller than a second conductive layer width in the second direction of the second conductive layer.

### CROSS-REFERENCE TO RELATED APPLICATIONS

This application is based upon and claims the benefit of priority from Japanese Patent Application No.2024-156569, filed on Sep. 10, 2024; the entire contents of which are incorporated herein by reference.

### FIELD

Embodiments described herein relate generally to a sensor.

### BACKGROUND

For example, there is a sensor that detects a flow rate or the like using a MEMS (Micro Electro Mechanical Systems) element, etc. It is desirable to improve the characteristics of the sensor.

### BRIEF DESCRIPTION OF THE DRAWINGS

FIGS. 1A and 1B are schematic views illustrating a sensor according to a first embodiment;

FIGS. 2A and 2B are schematic views illustrating a sensor according to the first embodiment;

FIG. 3 is a graph illustrating the characteristics of sensors;

FIG. 4 is a schematic cross-sectional view illustrating a sensor according to the first embodiment;

FIG. 5 is a schematic plan view illustrating a sensor according to the first embodiment; and

FIG. 6 is a schematic cross-sectional view illustrating a sensor according to a second embodiment.

### DETAILED DESCRIPTION

According to one embodiment, a sensor includes a base, a first structure, and a second structure. The first structure includes a first fixed portion fixed to the base, and a first element portion supported by the first fixed portion. The first element portion includes a first resistance layer and a first conductive layer provided between the base and the first resistance layer. A direction from the base to the first fixed portion is along a first direction. A first gap is provided between the base and the first element portion. The second structure includes a second fixed portion fixed to the base, and a second element portion supported by the second fixed portion. The second element portion includes a second resistance layer and a second conductive layer provided between the base and the second resistance layer. A second gap is provided between the base and the second element portion. A direction from the base to the second fixed portion is along the first direction. A second direction from the first element portion to the second element portion crosses the first direction. A first resistance layer width in the second direction of the first resistance layer is smaller than a first conductive layer width in the second direction of the first conductive layer. A second resistance layer width in the second direction of the second resistance layer is smaller than a second conductive layer width in the second direction of the second conductive layer.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

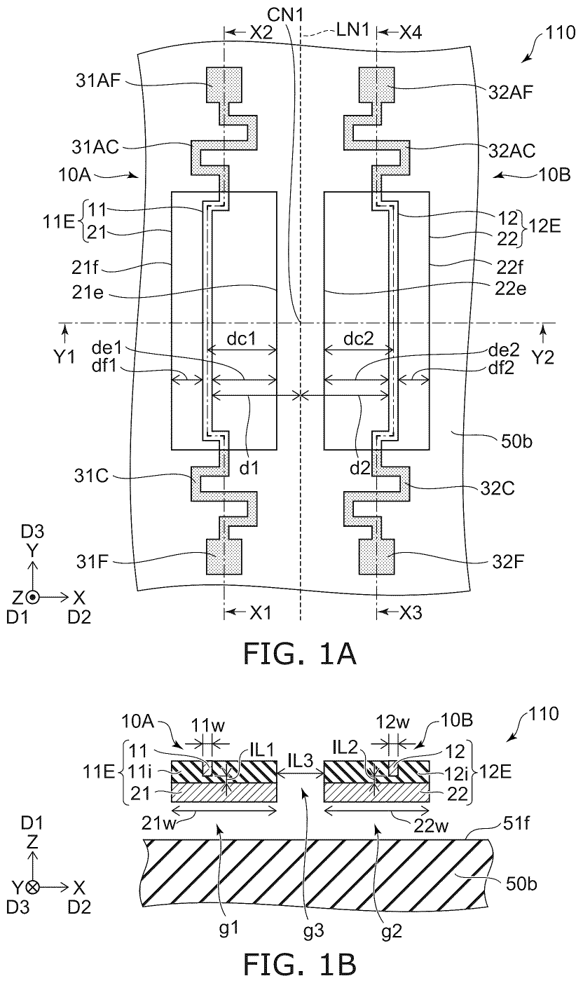

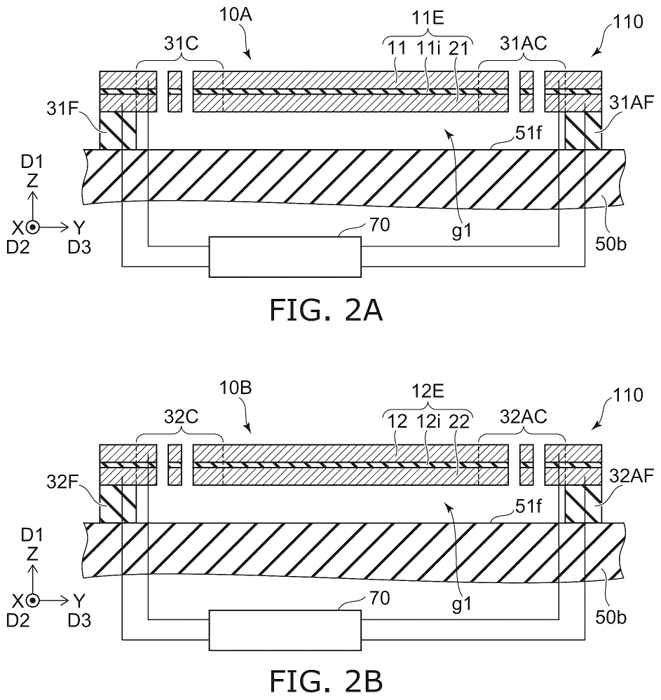

FIGS. 1A, 1B, 2A and 2B are schematic views illustrating a sensor according to a first embodiment.

FIG. 1A is a plan view. FIG. 1B is a cross-sectional view taken along the line Y1-Y2 of FIG. 1A. FIG. 2A is a cross-sectional view taken along the line X1-X2 of FIG. 1A. FIG. 2B is a cross-sectional view taken along the line X3-X4 of FIG. 1A.

As shown in FIG. 1A, a sensor 110 according to the embodiment includes a base 50b, a first structure 10A, and a second structure 10B.

The first structure 10A includes a first fixed portion 31F and a first element portion 11E. The first fixed portion 31F is fixed to the base 50b. The first element portion 11E is supported by the first fixed portion 31F.

The first element portion 11E includes a first resistance layer 11 and a first conductive layer 21. The first conductive layer 21 is provided between the base 50b and the first resistance layer 11.

A direction from the base 50b to the first fixed portion 31F is along a first direction D1. The first direction D1 is defined as a Z-axis direction. One direction perpendicular to the Z-axis direction is defined as an X-axis direction. A direction perpendicular to the Z-axis and X-axis directions is defined as a Y-axis direction.

For example, the base 50b includes a first face 51f. The first face 51f is along the X-Y plane, for example. The first fixed portion 31F is fixed to the first face 51f.

A first gap g1 is provided between the base 50b and the first element portion 11E.

The second structure 10B includes a second fixed portion 32F and a second element portion 12E. The second fixed portion 32F is fixed to the base 50b. For example, the second fixed portion 32F is fixed to the first face 51f. The second element portion 12E is supported by the second fixed portion 32F.

The second element portion 12E includes a second resistance layer 12 and a second conductive layer 22. The second conductive layer 22 is provided between the base 50b and the second resistance layer 12. A second gap g2 is provided between the base 50b and the second element portion 12E. The direction from the base 50b to the second fixed portion 32F is along the first direction D1.

A second direction D2 from the first element portion 11E to the second element portion 12E crosses the first direction D1. The second direction D2 is, for example, the X-axis direction.

As shown in FIG. 1A, a width of the first resistance layer 11 in the second direction D2 is defined as a first resistance layer width 11w. A width of the first conductive layer 21 in the second direction D2 is defined as a first conductive layer width 21w. In the embodiment, the first resistance layer width 11w is smaller than the first conductive layer width 21w.

As shown in FIG. 1A, a width of the second resistance layer 12 in the second direction D2 is defined as a second resistance layer width 12w. A width of the second conductive layer 22 in the second direction D2 is defined as a second conductive layer width 22w. In the embodiment, the second resistance layer width 12w is smaller than the second conductive layer width 22w. This results in high sensitivity, as described below.

In the sensor 110, for example, a value corresponding to the first electrical resistance R1 of the first resistance layer 11 when a first power is supplied to the first conductive layer 21 is detected. For example, the first power increases the temperature of the first resistance layer 11. The first electrical resistance R1 changes depending on the temperature.

For example, a value corresponding to the second electrical resistance R2 of the second resistance layer 12 when the second power is supplied to the second conductive layer 22 is detected. For example, the second power increases the temperature of the second resistance layer 12. The second electrical resistance R2 changes depending on the temperature.

In one example, the first power is the same as the second power. The temperature of the first resistance layer 11 increased by the first power is the same as the temperature of the second resistance layer 12 increased by the second power. In a state in which the same power is supplied, for example, when there is no flow in a detection target around the first element portion 11E and the second element portion 12E, the first electrical resistance R1 of the first resistance layer 11 is the same as the second electrical resistance R2 of the second resistance layer 12.

Meanwhile, for example, the detection target (for example, a fluid such as gas or liquid) passes around the first element portion 11E and the second element portion 12E. For example, when the detection target flows in a direction from the first element portion 11E to the second element portion 12E, a difference occurs between the first electrical resistance R1 and the second electrical resistance R2. This is because the flow of the detection target causes a difference in temperature between the first resistance layer 11 and the second resistance layer 12. By detecting the difference between the first electrical resistance R1 and the second electrical resistance R2, the flow of the detection target can be detected. The sensor 110 is, for example, a flow sensor.

For example, there is a first reference example in which a heater is provided between two resistance elements. The two resistance elements are heated by the radiation of heat from the heater. The detention target flows from one of the resistance elements to the other resistance element. In the first reference example, the flow of the detention target causes a difference in the electrical resistance of each of the two resistance elements. By detecting the difference, the flow of the detention target can be detected. Compared to this first reference example, the embodiment achieves high sensitivity.

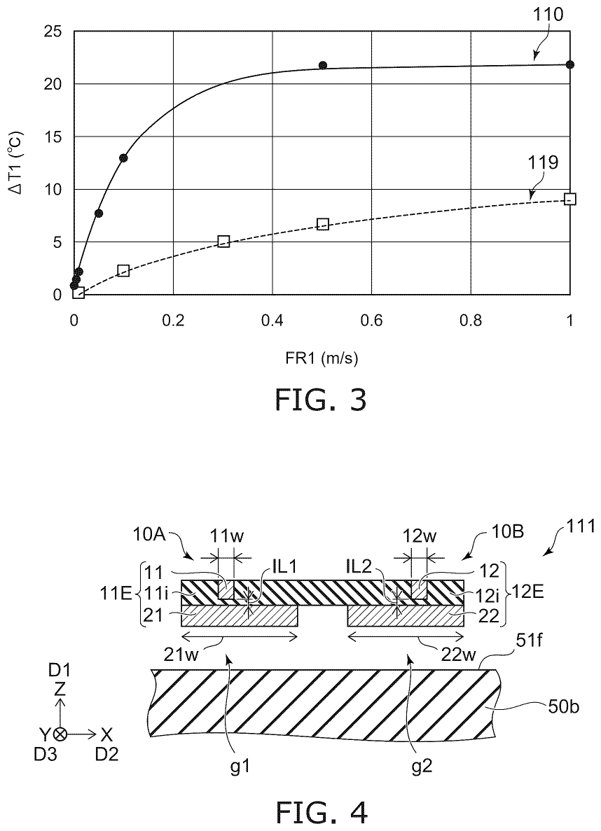

FIG. 3 is a graph illustrating the characteristics of sensors.

FIG. 3 illustrates the characteristics of the sensor 110 according to the embodiment and the characteristics of the sensor 119 of the first reference example. The horizontal axis of FIG. 3 is the flow rate FR1 to be detected. The vertical axis is the temperature difference ΔT1 between the two resistance elements. In the sensor 110, the same power is supplied to the first conductive layer 21 and the second conductive layer 22, and the first resistance layer 11 and the second resistance layer 12 are heated. In the sensor 110, the temperature difference ΔT1 is the difference between the temperature of the first resistance layer 11 and the temperature of the second resistance layer 12. As already explained, in the sensor 119, a heater is provided between the two resistance elements. Power is supplied to the heater and the two resistance elements are heated by radiation. In the sensor 119, the temperature difference ΔT1 is the temperature difference between the two resistance elements.

As shown in FIG. 3, the temperature difference ΔT1 being large is obtained in the sensor 110 compared to the sensor 119. In the sensor 110, a larger difference in electrical resistance is obtained due to the temperature difference ΔT1 being larger. This allows the flow of the detection target with high accuracy. According to the embodiment, a sensor capable of improving characteristics can be provided.

In the sensor 119 of the first reference example, two resistance elements are heated by radiation of heat from one heater. The heating efficiency is low. For this reason, it is thought that the temperature difference ΔT1 is small.

In the sensor 110 according to the embodiment, the first resistance layer 11 is stacked with the first conductive layer 21, and the second resistance layer 12 is stacked with the second conductive layer 22. For example, the distance between the resistance layer and the conductive layer is short. For example, the resistance layer is heated by thermal conduction. Efficient heating is possible. For example, it is considered that the flow of the detention target makes it easy for a temperature difference ΔT1 in the resistance layer to occur effectively.

Furthermore, two heaters (first conductive layer 21 and second conductive layer 22) are provided independently. The effect of heat from the first conductive layer 21 on the second resistance layer 12 is appropriately suppressed. The effect of heat from the second conductive layer 22 on the first resistance layer 11 is suppressed.

A second reference example is possible in which the first resistance layer 11 and the second resistance layer 12 are provided on a single conductive layer. In the second reference example, for example, the first resistance layer 11 and the second resistance layer 12 are heated by thermal conduction. However, the heat of the first resistance layer 11 is easily transferred to the second resistance layer 12 via the single conductive layer. For this reason, the temperature difference ΔT1 due to the flow of the detection target is likely to be small.

In contrast, in the sensor 110, two conductive layers are provided independently. Heat conduction through the conductive layers is suppressed. This makes it possible to increase the temperature difference ΔT1 caused by the flow of the detention target. In this embodiment, higher sensitivity is obtained compared to the second reference example.

As already explained, in the embodiment, the first resistance layer width 11w in the second direction D2 of the first resistance layer 11 is smaller than the first conductive layer width 21w in the second direction D2 of the first conductive layer 21. The second resistance layer width 12w in the second direction D2 of the second resistance layer 12 is smaller than the second conductive layer width 22w in the second direction D2 of the second conductive layer 22. This allows the first resistance layer 11 to be efficiently heated by the first conductive layer 21. The second resistance layer 12 can be efficiently heated by the second conductive layer 22. The effect of the heat of the second conductive layer 22 on the first resistance layer 11 can be suppressed. The effect of the heat of the first conductive layer 21 on the second resistance layer 12 can be suppressed. A large temperature difference is easily obtained. High sensitivity is easily obtained.

In one example, the first resistance layer width 11w is not less than 1/200 and not more than ½ of the first conductive layer width 21w. The second resistance layer width 12w is not less than 1/200 and not more than ½ of the second conductive layer width 22w. A large temperature difference is easily obtained. High sensitivity is easily obtained.

In the embodiment, for example, the first resistance layer area of the first resistance layer 11 is smaller than the first conductive layer area of the first conductive layer 21. For example, the second resistance layer area of the second resistance layer 12 is smaller than the second conductive layer area of the second conductive layer 22. A large temperature difference is easily obtained. High sensitivity is easily obtained.

As shown in FIG. 1B, a distance between the first conductive layer 21 and the first resistance layer 11 in the first direction D1 is defined as a first interlayer distance IL1. A distance between the first conductive layer 21 and the second conductive layer 22 in the second direction D2 is defined as a third interlayer distance IL3. The first interlayer distance IL1 is shorter than the third interlayer distance IL3. A distance between the second conductive layer 22 and the second resistance layer 12 in the first direction D1 is defined as a second interlayer distance IL2. The second interlayer distance IL2 is shorter than the third interlayer distance IL3. The first conductive layer 21 efficiently heats the first resistance layer 11. The second conductive layer 22 efficiently heats the second resistance layer 12. The influence of the first conductive layer 21 on the second resistance layer 12 is suppressed. The influence of the second conductive layer 22 on the first resistance layer 11 is suppressed.

As shown in FIG. 1B, the first element portion 11E may further include a first insulating member 11i. At least a part of the first insulating member 11i is provided between the first conductive layer 21 and the first resistance layer 11. The first resistance layer 11 is electrically insulated from the first conductive layer 21 by the first insulating member 11i.

The second element portion 12E may further include a second insulating member 12i. At least a part of the second insulating member 12i is provided between the second conductive layer 22 and the second resistance layer 12. The second resistance layer 12 is electrically insulated from the second conductive layer 22 by the second insulating member 12i. In this example, a third gap g3 is provided between the first insulating member 11i and the second insulating member 12i. This more effectively suppresses heat conduction.

As shown in FIG. 1B, the first resistance layer 11 may be provided between a part of the first insulating member 11i and another part of the first insulating member 11i in the second direction D2. The second resistance layer 12 may be provided between a part of the second insulating member 12i and another part of the second insulating member 12i in the second direction D2. For example, at least a part of the first resistance layer 11 may not be covered by the first insulating member 11i. For example, at least a part of the second resistance layer 12 may not be covered by the second insulating member 12i. The insulating member stabilizes the resistance layer. A large temperature difference is easily obtained.

As shown in FIG. 1A, it is preferable that the first resistance layer 11 and the second resistance layer 12 are line-symmetrical with respect to a first straight line LN1. The first straight line LN1 is perpendicular to the first direction D1 and the second direction D2. The first straight line LN1 is, for example, along the Y-axis direction. The first straight line LN1 passes through the center CN1 in the second direction D2 between the first conductive layer 21 and the second conductive layer 22. The first resistance layer 11 and second resistance layer 12 being line-symmetrical ensure that the influence from multiple conductive layers becomes same with no flow. This enables more accurate detection.

As shown in FIG. 1A, for example, a distance along the second direction D2 between the center CN1 and the first resistance layer 11 is defined as a first distance d1. The center CN1 is the center in the second direction D2 between the first conductive layer 21 and the second conductive layer 22. A distance along the second direction D2 between the center CN1 and the second resistance layer 12 is defined as a second distance d2. In the embodiment, it is preferable that the ratio of the absolute value of the difference between the first distance d1 and the second distance d2 to the first distance d1 is 0.1 or less. For example, it is preferable that the first distance d1 is substantially the same as the second distance d2. Thereby, for example, the difference in the influence from multiple conductive layers is suppressed in the case where there is no flow,. Higher accuracy of detection is possible.

As shown in FIG. 1A, the first conductive layer 21 includes a first end 21e and a first other end 21f. The second conductive layer 22 includes a second end 22e and a second other end 22f. The first end 21e is between the first other end 21f and the second other end 22f in the second direction D2. The second end 22e is between the first end 21e and the second other end 22f in the second direction D2. The center CN1 is between the first end 21e and the second end 22e.

A distance along the second direction D2 between the first other end 21f and the first resistance layer 11 is defined as a first other end distance df1. A distance along the second direction D2 between the first resistance layer 11 and the first end 21e is defined as a first end distance de1. It is preferable that the first other end distance df1 is shorter than the first end distance de1.

A distance along the second direction D2 between the second resistance layer 12 and the second other end 22f is defined as a second other end distance df2. A distance along the second direction D2 between the second end 22e and the second resistance layer 12 is defined as a second end distance de2. It is preferable that the second other end distance df2 is shorter than the second end distance de2.

Due to these distance relationships, the first resistance layer 11 is less susceptible to the influence of the second conductive layer 22. The second resistance layer 12 is less susceptible to the influence of the first conductive layer 21. It becomes easier to obtain a larger temperature difference ΔT1. For example, higher sensitivity detection becomes possible.

For example, the first other end distance df1 may be not less than 0.1 times and not more than 0.8 times the first end distance de1. The second other end distance df2 may be not less than 0.1 times and not more than to 0.8 times the second end distance de2.

A distance along the second direction D2 between the center position in the second direction D2 of the first resistance layer 11 and the first end 21e is defined as a first shift distance dc1. A ratio of the first shift distance dc1 to the first conductive layer width 21w may be, for example, not less than 0.6 and not more than 0.9. A distance along the second direction D2 between the center position in the second direction D2 of the second resistance layer 12 and the second end 22e is defined as a second shift distance dc2. A ratio of the second shift distance dc2 to the second conductive layer width 22w may be, for example, not less than 0.6 and not more than 0.9. This facilitates detection with higher accuracy.

As shown in FIGS. 2A and 2B, a controller 70 may be provided. The controller 70 may be included in the sensor 110. The controller 70 may be provided separately from the sensor 110. The controller 70 is electrically connected to the first conductive layer 21 and the first resistance layer 11. The controller 70 is electrically connected to the second conductive layer 22 and the second resistance layer 12.

The controller 70 is configured to supply a first power to the first conductive layer 21 and a second power to the second conductive layer 22. The controller 70 may be configured to detect a first electrical resistance R1 of the first resistance layer 11 and a second electrical resistance R2 of the second resistance layer 12. The controller 70 is configured to detect a value corresponding to the difference between the first electrical resistance R1 and the second electrical resistance R2.

As already explained, the detection target flowing through the first element portion 11E and the second element portion 12E in the second direction D2 is detected by a value corresponding to the difference between the first electrical resistance R1 of the first resistance layer 11 when the first power is supplied to the first conductive layer 21, and the second electrical resistance R2 of the second resistance layer 12 when the second power is supplied to the second conductive layer 22.

As shown in FIGS. 1A and 2A, the first structure 10A may further include a first other fixed portion 31AF fixed to the base 50b. The first element portion 11E is further supported by the first other fixed portion 31AF. The first element portion 11E is located between the first fixed portion 31F and the first other fixed portion 31AF in the third direction D3. The third direction D3 crosses a plane including the first direction D1 and the second direction D2.

As shown in FIGS. 1A and 2B, the second structure 10B may further include a second other fixed portion 32AF fixed to the base 50b. The second element portion 12E is further supported by the second other fixed portion 32AF. The second element portion 12E is located between the second fixed portion 32F and the second other fixed portion 32AF in the third direction D3.

As shown in FIGS. 1A and 2A, the first structure 10A may further include a first connection portion 31C and a first other connection portion 31AC. The first connection portion 31C is provided between the first fixed portion 31F and the first element portion 11E. The first other connection portion 31AC is provided between the first other fixed portion 31AF and the first element portion 11E.

As shown in FIGS. 1A and 2B, the second structure 10B may further include a second connection portion 32C and a second other connection portion 32AC. The second connection portion 32C is provided between the second fixed portion 32F and the second element portion 12E. The second other connection portion 32AC is provided between the second other fixed portion 32AF and the second element portion 12E.

Gaps are provided between the first connection portion 31C, the first other connection portion 31AC, the second connection portion 32C, and the second other connection portion 32AC and the base 50b. At least one of the first connection portion 31C, the first other connection portion 31AC, the second connection portion 32C, and the second other connection portion 32AC may have a meandering structure.

FIG. 4 is a schematic cross-sectional view illustrating a sensor according to the first embodiment.

FIG. 4 is a cross-sectional view corresponding to line Y1-Y2 in FIG. 1A. As shown in FIG. 4, in a sensor 111 according to the embodiment, the configuration of the insulating member is different from the configuration of the insulating member in the sensor 110. Except for this, the configuration of the sensor 111 may be the same as the configuration of the sensor 110.

In the sensor 111, the second insulating member 12i is continuous with the first insulating member 11i. For example, the first element portion 11E and the second element portion 12E become more stable. In the sensor 111, a sensor whose characteristics can be improved can also be provided.

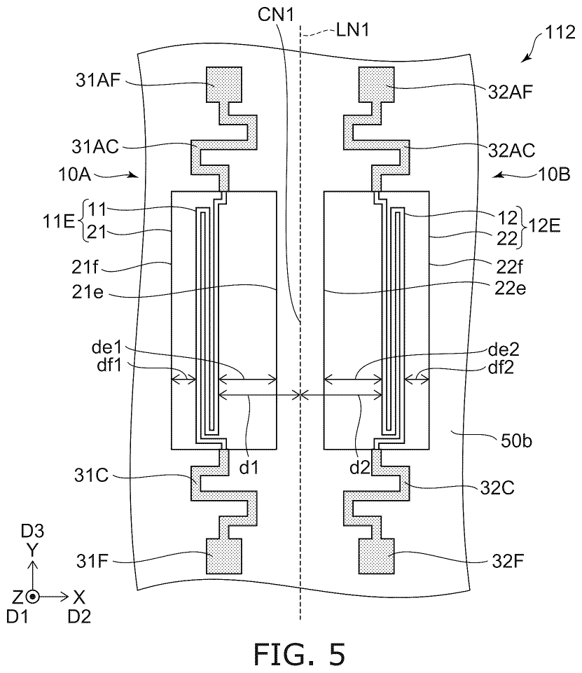

FIG. 5 is a schematic plan view illustrating a sensor according to the first embodiment.

As shown in FIG. 5, in a sensor 112 according to the embodiment, the shapes of the first resistance layer 11 and the second resistance layer 12 differ from the shapes of the first resistance layer 11 and the second resistance layer 12 in the sensor 110. Except for this, the configuration of sensor 112 may be similar to the configuration of sensor 110 or sensor 111.

In the sensor 112, the first resistance layer 11 and the second resistance layer 12 have a meandering structure. When at least one of the first resistance layer 11 and the second resistance layer 12 has a meandering structure, a sensor capable of improving characteristics can be provided.

In the sensor 112, the ratio of the absolute value of the difference between the first distance d1 and the second distance d2 to the first distance d1 may be 0.1 or less. The first distance d1 may be substantially the same as the second distance d2. For example, the first other end distance df1 is shorter than the first end distance de1. For example, the second other end distance df2 is shorter than the second end distance de2. For example, the first other end distance df1 may be not less than 0.1 times and not more than 0.8 times the first end distance de1. The second other end distance df2 may be not less than 0.1 times and not more than 0.8 times the second end distance de2.

### Second Embodiment

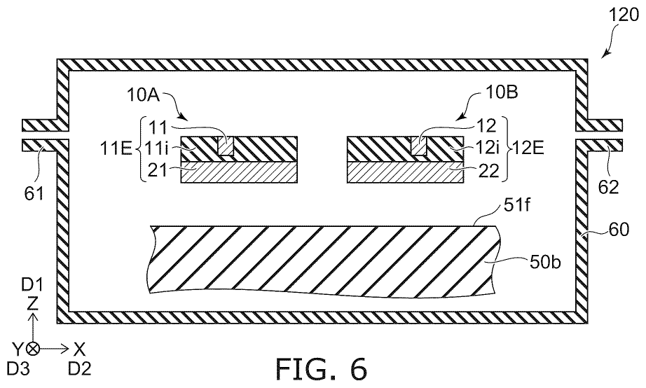

FIG. 6 is a schematic cross-sectional view illustrating a sensor according to a second embodiment.

As shown in FIG. 6, a sensor 120 according to the embodiment further includes a housing 60. The configuration of the sensor 120 except for this may be the same as the configuration of the sensors 110 to 112.

In the sensor 120, the housing 60 includes a first opening 61 and a second opening 62. The base 50b, the first structure 10A, and the second structure 10B are provided inside the housing 60. The direction from the first opening 61 to the second opening 62 is along the second direction D2. For example, the detention target flows from the first opening 61 toward the second opening 62. The flow of the detention target is effectively detected.

Embodiments may include the following Technical proposals:

### Technical Proposal 1

A sensor, comprising:
a base;
a first structure; and
a second structure,
the first structure including
   a first fixed portion fixed to the base, and
   a first element portion supported by the first fixed portion,
the first element portion including a first resistance layer and a first conductive layer provided between the base and the first resistance layer,
a direction from the base to the first fixed portion being along a first direction,
a first gap being provided between the base and the first element portion,
the second structure including a second fixed portion fixed to the base, and a second element portion supported by the second fixed portion,
the second element portion including a second resistance layer and a second conductive layer provided between the base and the second resistance layer,
a second gap being provided between the base and the second element portion,
a direction from the base to the second fixed portion being along the first direction,
a second direction from the first element portion to the second element portion crossing the first direction,
a first resistance layer width in the second direction of the first resistance layer being smaller than a first conductive layer width in the second direction of the first conductive layer, and
a second resistance layer width in the second direction of the second resistance layer being smaller than a second conductive layer width in the second direction of the second conductive layer.

### Technical Proposal 2

The sensor according to Technical proposal 1, wherein
a detection target flowing through the first element portion and the second element portion along the second direction is detected by a value corresponding to a difference between a first electrical resistance of the first resistance layer when a first power is supplied to the first conductive layer and a second electrical resistance of the second resistance layer when a second power is supplied to the second conductive layer.

### Technical Proposal 3

The sensor according to Technical proposal 2, further comprising:
controller,
the controller being configured to supply the first power to the first conductive layer and the second power to the second conductive layer, and
the controller being configured to detect the value.

### Technical Proposal 4

The sensor according to any one of Technical proposals 1-3, wherein
a first resistance layer area of the first resistance layer is smaller than a first conductive layer area of the first conductive layer, and
a second resistance layer area of the second resistance layer is smaller than a second conductive layer area of the second conductive layer.

### Technical Proposal 5

The sensor according to any one of Technical proposals 1-4, wherein
a ratio of an absolute value of a difference between a first distance and a second distance to the first distance is equal to or less than 0.1,
the first distance is a distance along the second direction between the first resistance layer and a center in the second direction between the first conductive layer and the second conductive layer, and
the second distance is a distance along the second direction between the center and the second resistance layer.

### Technical Proposal 6

The sensor according to Technical proposal 5, wherein the first distance is substantially the same as the second distance.

### Technical Proposal 7

The sensor according to any one of Technical proposals 1-4, wherein
the first resistance layer and the second resistance layer are symmetrical with respect to a first straight line,
the first straight line is perpendicular to the first direction and the second direction,
the first straight line passes through a center in the second direction between the first conductive layer and the second conductive layer.

### Technical Proposal 8

The sensor according to any one of Technical proposals 1-7, wherein
the first conductive layer includes a first end and a first other end,
the second conductive layer includes a second end and a second other end,
the first end is between the first other end and the second other end in the second direction,
the second end is between the first end and the second other end in the second direction,
a first other end distance along the second direction between the first other end and the first resistance layer is shorter than a first end distance along the second direction between the first resistance layer and the first end, and
a second other end distance along the second direction between the second resistance layer and the second other end is shorter than a second end distance along the second direction between the second end and the second resistance layer.

### Technical Proposal 9

The sensor according to Technical proposal 8, wherein the first other end distance is not less than 0.1 times and not more than 0.8 times the first end distance, and the second other end distance is not less than 0.1 times and not more than 0.8 times the second end distance.

### Technical proposal 10

The sensor according to any one of Technical proposals 1-9, wherein
the first resistance layer width is not less than 1/200 and not more than ½ of the first conductive layer width, and
the second resistance layer width is not less than 1/200 and not more than ½ of the second conductive layer width.

### Technical Proposal 11

The sensor according to any one of Technical proposals 1-10, wherein
a first interlayer distance between the first conductive layer and the first resistance layer along the first direction is shorter than a third interlayer distance between the first conductive layer and the second conductive layer along the second direction, and
a second interlayer distance between the second conductive layer and the second resistance layer in the first direction is shorter than the third interlayer distance.

### Technical Proposal 12

The sensor according to any one of Technical proposals 1-11, wherein
the first element portion further includes a first insulating member,
at least a part of the first insulating member is provided between the first conductive layer and the first resistance layer,
the second element portion further includes a second insulating member, and
at least a part of the second insulating member is provided between the second conductive layer and the second resistance layer.

### Technical Proposal 13

The sensor according to Technical proposal 12, wherein a third gap is provided between the first insulating member and the second insulating member.

### Technical proposal 14

The sensor according to Technical proposal 12, wherein
the second insulating member is continuous with the first insulating member.

### Technical proposal 15

The sensor according to any one of Technical proposals 12-14, wherein
the first resistance layer is between a part of the first insulating member and another part of the first insulating member in the second direction, and
the second resistance layer is between a part of the second insulating member and another part of the second insulating member in the second direction.

### Technical Proposal 16

The sensor according to any one of Technical proposals 12-15, wherein
at least a part of the first resistance layer is not covered by the first insulating member, and
at least a part of the second resistance layer is not covered by the second insulating member.

### Technical Proposal 17

The sensor according to any one of Technical proposals 1-16, wherein
the first structure further includes a first other fixed portion fixed to the base,
the first element portion is further supported by the first other fixed portion,
the first element portion is located between the first fixed portion and the first other fixed portion in a third direction crossing a plane including the first direction and the second direction,
the second structure further includes a second other fixed portion fixed to the base,
the second element portion is further supported by the second other fixed portion, and
the second element portion is located between the second fixed portion and the second other fixed portion in the third direction.

### Technical Proposal 18

The sensor according to Technical proposal 17, wherein
the first structure further includes
   a first connection portion provided between the first fixed portion and the first element portion, and
   a first other connection portion provided between the first other fixed portion and the first element portion,
the second structure further includes
   a second connection portion provided between the second fixed portion and the second element portion, and
   a second other connection portion provided between the second other fixed portion and the second element portion,
at least one of the first connection portion, the first other connection portion, the second connection portion, and the second other connection portion has a meander structure.

### Technical Proposal 19

The sensor according to any one of Technical proposals 1-17, wherein
at least one of the first resistance layer and the second resistance layer has a meandering structure.

### Technical Proposal 20

The sensor according to any one of Technical proposals 1-19, further comprising:
a housing including a first opening and a second opening,
the base, the first structure, and the second structure being provided in the housing, and
a direction from the first opening to the second opening being along the second direction.

According to the embodiment, a sensor can be provided that allows for improved characteristics.

In the specification, “electrically connected” includes a state in which plurality of conductors are physically in contact with each other and current flows between these plurality of conductors. “Electrically connected” includes a state in which a conductor is inserted between plurality of conductors and current flows between these plurality of conductors.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in sensors such as bases, structures, controllers, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all sensors practicable by an appropriate design modification by one skilled in the art based on the sensors described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A sensor, comprising:
a base;
a first structure; and
a second structure,
the first structure including
a first fixed portion fixed to the base, and
a first element portion supported by the first fixed portion,
the first element portion including a first resistance layer and a first conductive layer provided between the base and the first resistance layer,
a direction from the base to the first fixed portion being along a first direction,
a first gap being provided between the base and the first element portion,
the second structure including a second fixed portion fixed to the base, and a second element portion supported by the second fixed portion,
the second element portion including a second resistance layer and a second conductive layer provided between the base and the second resistance layer,
a second gap being provided between the base and the second element portion,
a direction from the base to the second fixed portion being along the first direction,
a second direction from the first element portion to the second element portion crossing the first direction,
a first resistance layer width in the second direction of the first resistance layer being smaller than a first conductive layer width in the second direction of the first conductive layer, and
a second resistance layer width in the second direction of the second resistance layer being smaller than a second conductive layer width in the second direction of the second conductive layer.

2. The sensor according to claim 1, wherein
a detection target flowing through the first element portion and the second element portion along the second direction is detected by a value corresponding to a difference between a first electrical resistance of the first resistance layer when a first power is supplied to the first conductive layer and a second electrical resistance of the second resistance layer when a second power is supplied to the second conductive layer.

3. The sensor according to claim 2, further comprising:
controller,
the controller being configured to supply the first power to the first conductive layer and the second power to the second conductive layer, and
the controller being configured to detect the value.

4. The sensor according to claim 1, wherein
a first resistance layer area of the first resistance layer is smaller than a first conductive layer area of the first conductive layer, and
a second resistance layer area of the second resistance layer is smaller than a second conductive layer area of the second conductive layer.

5. The sensor according to claim 1, wherein
a ratio of an absolute value of a difference between a first distance and a second distance to the first distance is equal to or less than 0.1,
the first distance is a distance along the second direction between the first resistance layer and a center in the second direction between the first conductive layer and the second conductive layer, and
the second distance is a distance along the second direction between the center and the second resistance layer.

6. The sensor according to claim 5, wherein
the first distance is substantially the same as the second distance.

7. The sensor according to claim 1, wherein
the first resistance layer and the second resistance layer are symmetrical with respect to a first straight line,
the first straight line is perpendicular to the first direction and the second direction,
the first straight line passes through a center in the second direction between the first conductive layer and the second conductive layer.

8. The sensor according to claim 1, wherein
the first conductive layer includes a first end and a first other end,
the second conductive layer includes a second end and a second other end,
the first end is between the first other end and the second other end in the second direction,
the second end is between the first end and the second other end in the second direction,
a first other end distance along the second direction between the first other end and the first resistance layer is shorter than a first end distance along the second direction between the first resistance layer and the first end, and
a second other end distance along the second direction between the second resistance layer and the second other end is shorter than a second end distance along the second direction between the second end and the second resistance layer.

9. The sensor according to claim 8, wherein
the first other end distance is not less than 0.1 times and not more than 0.8 times the first end distance, and
the second other end distance is not less than 0.1 times and not more than 0.8 times the second end distance.

10. The sensor according to claim 1, wherein
the first resistance layer width is not less than 1/200 and not more than ½ of the first conductive layer width, and
the second resistance layer width is not less than 1/200 and not more than ½ of the second conductive layer width.

11. The sensor according to claim 1, wherein
a first interlayer distance between the first conductive layer and the first resistance layer along the first direction is shorter than a third interlayer distance between the first conductive layer and the second conductive layer along the second direction, and
a second interlayer distance between the second conductive layer and the second resistance layer in the first direction is shorter than the third interlayer distance.

12. The sensor according to claim 1, wherein
the first element portion further includes a first insulating member,
at least a part of the first insulating member is provided between the first conductive layer and the first resistance layer,
the second element portion further includes a second insulating member, and
at least a part of the second insulating member is provided between the second conductive layer and the second resistance layer.

13. The sensor according to claim 12, wherein
a third gap is provided between the first insulating member and the second insulating member.

14. The sensor according to claim 12, wherein
the second insulating member is continuous with the first insulating member.

15. The sensor according to claim 12, wherein
the first resistance layer is between a part of the first insulating member and another part of the first insulating member in the second direction, and
the second resistance layer is between a part of the second insulating member and another part of the second insulating member in the second direction.

16. The sensor according to claim 12, wherein
at least a part of the first resistance layer is not covered by the first insulating member, and
at least a part of the second resistance layer is not covered by the second insulating member.

17. The sensor according to claim 1, wherein
the first structure further includes a first other fixed portion fixed to the base,
the first element portion is further supported by the first other fixed portion,
the first element portion is located between the first fixed portion and the first other fixed portion in a third direction crossing a plane including the first direction and the second direction,
the second structure further includes a second other fixed portion fixed to the base,
the second element portion is further supported by the second other fixed portion, and
the second element portion is located between the second fixed portion and the second other fixed portion in the third direction.

18. The sensor according to claim 17, wherein
the first structure further includes
a first connection portion provided between the first fixed portion and the first element portion, and
a first other connection portion provided between the first other fixed portion and the first element portion,
the second structure further includes
a second connection portion provided between the second fixed portion and the second element portion, and
a second other connection portion provided between the second other fixed portion and the second element portion,
at least one of the first connection portion, the first other connection portion, the second connection portion, and the second other connection portion has a meander structure.

19. The sensor according to claim 1, wherein
at least one of the first resistance layer and the second resistance layer has a meandering structure.

20. The sensor according to claim 1, further comprising:
a housing including a first opening and a second opening,
the base, the first structure, and the second structure being provided in the housing, and
a direction from the first opening to the second opening being along the second direction.
